(19) United States
(12) Patent Application Publication
(10) Pub. No.: US 2008/0102226 A1
(43) Pub. Date: May 1, 2008

(54) Polyarylate Optical Compensator Film For Lcd And Method For Preparing The Same

(75) Inventors: Ho-jun Lee, Daejeon (KR); Dong-ryul Kim, Daejeon (KR); Sang-uk Ryu, Daejeon (KR); Hee-jung Kim, Daejeon (KR)

Correspondence Address: MCKENNA LONG & ALDRIDGE LLP, 1900 K STREET, NW, WASHINGTON, DC, 20006, US

(73) Assignee: LG CHEM, LTD., Seoul (KR)

(21) Appl. No.: 11/663,496

(22) PCT Filed: Sep. 22, 2005
(86) PCT No.: PCT/KR05/03142

§ 371 Date: Mar. 22, 2007

(30) Foreign Application Priority Data
Sep. 22, 2004 (KR) 10-2004-0075903

(51) Int. Cl. C09K 19/38

(52) U.S. Cl. 428/1.1

(57) ABSTRACT

The present invention relates to a polyarylate film having high level of negative phase difference toward out of plane direction, which is good enough to be used as an optical compensator film providing wide view angle. The polyarylate film prepared in the present invention has bigger birefringence toward out of plane direction than that of polymer for the conventional compensator film, suggesting that it not only reduces the thickness of the final product but also has the effect of optical compensation only with thin film coating.

### TECHNICAL FIELD

The present invention relates to a negative C type optical compensator film for LCD to improve wide view angle and a preparation method of the same, more precisely, a polyarylate optical compensator film to be used as a negative C type compensator film for LCD providing improved wide view angle without stretching process owing to its high negative birefringence in out of plane direction and to reduce remarkably the thickness of the compensator film, and a preparation method of the same.

### BACKGROUND ART

Polyarylate is polyester composed of bisphenol A/isophthalate/terephthalate. Polyarylate film has high optical transmittance and excellent mechanical and thermal properties. However, it still has problems of high melting temperature and viscosity and generating positive birefringence in in-plane direction during the processing. To utilize polyarylate as an optical film, a technique to regulate the birefringence in in-plane direction has been a key point of studies.

Liquid crystal display has narrow view angle attributed to liquid crystal molecules and fundamental optical characteristics of polarizer. To widen the narrow view angle, a substance capable of delaying phase difference of light is used. The phase difference of light is delayed in two directions; out of plane direction and in-plane direction of a film. And a substance having birefringence toward each direction is used. In general, a substance having birefringence toward in-plane direction is used to produce A type optical compensator film, which can be prepared by orienting polymer chain in in-plane direction by stretching polymer film in in-plane direction. In the meantime, a substance having birefringence toward out of plane direction, which is used to produce C type compensator film, is prepared by biaxial stretching of film after extrusion or solution casting. However, birefringence toward out of plane direction is less obtained from biaxial stretching, which even changes reflective index toward in-plane direction, so the method is limited in regulation of phase difference in each direction. Excessive stretching of a film at low temperature, to obtain high level of birefringence, results in the decrease of thickness of a film and irregular birefringence thereon.

Phase difference of a compensator film is defined as the below mathematical formula 1. Herein, without birefringence toward in-plane direction (nₓ=n_{y}), when nₓ is bigger than n_{z}, Rₜₕ has negative value, and when nₓ is smaller than n_{z}, Rₜₕ has positive value.

$${R}_{th} = ( {n}_{z} - \frac{{n}_{x} + {n}_{y}}{2} ) \times d \qquad [ Mathematical Formula 1 ]$$

Wherein, Rₜₕ indicates phase difference toward out of plane direction, nₓ and n_{y} indicate reflective index toward in-plane direction of film, n_{z} indicates reflective index toward out of plane direction of film and d indicates the film thickness.

To show birefringence, polymer chain has to be oriented at a right-angle to the face of film or at in-plane direction, or at least a part of the polymer chain has to be oriented likewise. At this time, the axis of the polymer chain is used as optical axis. If optical axis stands at in-plane direction, the film is produced as A type compensator film, and if optical axis stands at right-angle to the face of film, the film is produced as C type compensator film. Each code is determined as positive or negative code according to reflective index, and when reflective index is less than optical axis, a code is shown as positive. When reflective index is bigger than optical axis, a code is shown as negative. Most polymers show positive birefringence, though it has different levels, suggesting that reflective index at polymer chain axis is bigger than that at the right-angle (nₓ>n_{y}≧n_{z}). Orientation of polymer chain depends on the components of a polymer, thickness of a film, drying condition of a solvent, etc. In particular, when the thickness of a film reduces as molecular level, the orientation of polymer on the surface of a film is maximized, generating extremely high level of birefringence.

Since liquid crystal molecule has positive birefringence, a substance having negative birefringence has to be used to compensate it. One of the representative polymers having negative birefringence is polystyrene. Uniaxial or biaxial stretching leads to the orientation of optical axis toward the in-plane direction of a film, providing negative birefringence at a low level.

As LCD is being widened, a compensator film is necessary to secure wide view angle. The conventional film having phase difference toward out of plane direction for providing wide view angle has been produced by uniaxial or biaxial stretching of cellulose or polycarbonate polymer film or by coating polymer film with liquid crystal molecules. However, birefringence generated by stretching is not easy to be regulated. In addition, the stretching reduces the film thickness, reducing the chance of obtaining proper phase difference.

Japanese Patent Publication No. JP2001-194668 describes preparation of a compensator film by laminating stretched polycarbonate film. This method requires complicated laminating processes, in which optical axis has to be crossed when two films are placed on each other. U.S. Pat. No. 5,043,413 introduced a preparation method for polyarylate having low level of birefringence toward in-plane direction, in which polyarylate film was produced by solvent casting and stretched to compare its birefringence with those of other films. Stretched polyarylate film having low level of birefringence up to 25.7×10⁻⁵ was polymerized. The stretching generates birefringence toward in-plane direction, which is not proper for C type compensator film requiring birefringence toward out of plane direction. U.S. Pat. No. 5,285,303 describes a method to prepare polyarylate film for compensator film providing wide view angle by uniaxial stretching and to produce birefringence toward thickness direction by contraction in stretching direction and at cross-angle. In general, phase difference of liquid crystal is 100˜400 nm and to compensate the phase difference was needed an opposite symbol with 100˜400 nm. Stretching reduces the thickness of a film and also makes orientation of polymer difficult, showing the limitation in producing proper phase difference.

### DISCLOSURE OF INVENTION

It is an object of the present invention, to solve the above problems, to provide a polyarylate compensator film having high level of negative birefringence toward out of plane direction which can reduce the thickness of the film remarkably and be used as a negative C type compensator film without being through stretching process, and a preparation method of the same.

The object of the present invention is achieved by the following embodiments of the present invention.

To achieve the above object, the present invention provides an optical compensator film for LCD, which characteristically is a polyarylate film having phase difference of −30 nm˜−2000 nm defined as mathematical formula 1.

$${R}_{th} = ( {n}_{z} - \frac{{n}_{x} + {n}_{y}}{2} ) \times d \qquad [ Mathematical Formula 1 ]$$

Wherein, Rₜₕ indicates the phase difference toward out of plane direction, nₓ and n_{y} indicate reflective index toward in-plane direction of film, n_{z} indicates reflective index toward out of plane direction of film and d indicates the film thickness (nm).

It is preferred for the polyarylate film to have phase difference of −30 nm˜−300 nm.

For the polyarylate, a polymer represented by the following formula 1 can be used.

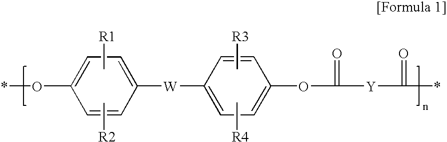

Wherein, R1, R2, R3 and R4 are independently hydrogen, C₁˜C₁₂ alkyl, C₆˜C₁₂ arylalkyl), C₆˜C₁₂ aryl, C₁˜C₁₂ nitrile, C₁˜C₁₂ alkoxy, C₁˜C₁₂ acyl or halogen, W is C₁˜C₃₀ alkylidene, C₂˜C₃₀ alkylene, C₃˜C₃₀ cycloalkylidene, C₃˜C₃₀ cycloalkylene or phenyl-substituted C₂˜C₃₀ alkylene, fluorene, oxygen, sulfur, sulfoxide, sulfone or single bond.

And, —OOCYCO— can be one of terephthalic acid, isophthalic acid, dibenzoic acid or naphthalene dicarboxylic acid in which aromatic group can be substituted with a substituent selected from a group consisting of C₁˜C₈ alkyl, aryl, alkylaryl and halogen, and/or a mixture comprising at least two of the above.

For the polyarylate, homopolymer or copolymer of more than two polymers can be used, and homopolymer composed of single monomers is preferred.

It is also preferred for the polyarylate to be homopolymer prepared by polymerization with a monomer selected from a group consisting of 2,2-bis(4-hydroxyphenyl)propane (BPA), 4,4-dihydroxyphenyl-9,9-fluorene, 2,2-bis(4-hydroxyphenyl)fluorene (BHPF), 9,9-bis(3,5-dimethyl-4-hydroxyphenyl)fluorene (BDMPF) and 9,9-bis(3,5-dibromo-4-hydroxyphenyl)fluorene (BFBPF) and another monomer selected among isophthaloyl chloride and terephthaloyl chloride.

The polyarylate copolymer can be produced from monomers containing fluorene group.

The polyarylate homopolymer can have phase difference level of −5 nm/μm˜−15 nm/μm as defined in the below mathematical formula 2.

$${r}_{th} = \frac{{R}_{th}}{t} \qquad [ Mathematical Formula 2 ]$$

Wherein, rₜₕ indicates the phase difference per unit thickness, Rₜₕ indicates the phase difference toward out of plane direction (nm), and t indicates the film thickness (μm).

The polyarylate copolymer can also have phase difference level of −0.5 nm/μm˜−10 nm/μm as defined in the above mathematical formula 2.

The molecular weight of polyarylate is at least 20,000 g/mol.

The polyarylate can be synthesized by using diatomic phenol and diatomic aromatic carboxylic acid halide as major components.

The polyarylate film can be surface-treated by a method selected from a group consisting of corona treatment, acid/base treatment and UV treatment.

The thickness of the polyarylate film can be up to 200 μm.

The mentioned compensator film for LCD can be applied to vertical alignment LCD, twist nematic LCD or sheet switching LCD.

The present invention also provides a preparation method for polyarylate compensator film comprising the following steps: preparing polyarylate solution by using one or more organic solvents selected from a group consisting of methylenechloride, dichloroethane and tetrahydrofuran; preparing cast film by coating a substrate with the polyarylate solution and vaporizing solvents slowly at room temperature or up to 50° C. not to affect the productivity of film; preparing polyarylate compensator film with minimized internal stress by fixing the cast film on a frame designed to receive force evenly and drying thereof.

The polyarylate solution above can include polymer by 5˜30 weight %. If the content of the polymer is out of the range, viscosity of the solution will be too high or low to coat, and solubility of polymer will be another problem.

Hereinafter, the present invention is described in detail.

In the present invention, polyarylate can be prepared by polymerization with either bisphenol A only or bisphenol A and 9,9-bis(4-hydroxyphenol)fluorene. The polymerized polyarylate is dissolved in solvents like methylenechloride, dichloroethane and tetrahydrofuran, resulting in 5˜25 weight % solution. The polyarylate solution was placed on glass plate by bar coating method at room temperature for coating, and then solvents were serially vaporized, leading to the preparation of 10˜100 μm thick film. Rapid vaporization of solvents causes contraction of a film, making the surface of a film uneven. Thus, cast film was prepared first from polymer, which was then fixed and dried to prepare a target film. The temperature had to be raised slowly, during the drying, to prevent sagging at high temperature, so that a flat surface film was prepared. The remaining solvent in the film solution should be less than 0.05% to proceed to drying at 200° C. Then, phase differences toward in-plane direction and out of plane direction of the produced film were measured. Another polyarylate having different glass transition temperature was polymerized by changing the content of monomers containing fluorine group for bisphenol A. That is, birefringence rate of the polymerized film could be regulated by regulating the content of monomers containing fluorene group for bisphenol A. The polymerized polyarylate was processed to films having different thicknesses and phase differences of them were measured. Phase difference was generated during the vaporization of a solvent and orientation of polymer chain, so the kind and vaporizing speed of a solvent could affect phase difference of a film. In the meantime, internal stress was generated by the contraction of a film during drying, so minimization of internal stress was required to minimize birefringence toward in-plane direction. A small amount of additive could be added to improve surface properties of a film.

Polyarylate represented by the following formula 1 can be used in the present invention.

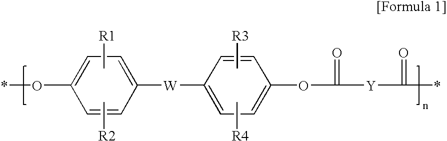

Wherein, R1, R2, R3 and R4 are independently hydrogen, C₁˜C₁₂ alkyl, C₆˜C₁₂ arylalkyl), C₆˜C₁₂ aryl, C₁˜C₁₂ nitrile, C₁˜C₁₂ alkoxy, C₁˜C₁₂ acyl or halogen, W is C₁˜C₃₀ alkylidene, C₂˜C₃₀ alkylene, C₃˜C₃₀ cycloalkylidene, C₃˜C₃₀ cycloalkylene or phenyl-substituted C₂˜C₃₀ alkylene, fluorene, oxygen, sulfur, sulfoxide, sulfone or single bond. The applicable aromatic dihydroxy compound is bis(4-hydroxyaryl)alkane, more specifically bis(4-hydroxyphenyl)methane, 2,2-bis(4-hydroxyphenyl)propane (BPA), 2,2-bis(4-hydroxyphenyl)ethane, 2,2-bis(4-hydroxy-3-methylphenyl)propane, 2,2-bis(4-hydroxyphenyl)heptane, 2,2-bis(4-hydroxy-3,5-dichlorophenyl)propane, 2,2-bis(4-hydroxy-3,5-dibromophenyl)propane, bis(4-hydroxyphenyl) phenylmethane, 4,4-dihydroxyphenyl-1,1-m-diisopropylbenzene, 4,4-dihydroxyphenyl-9,9-fluorene, 2,2-bis(4-hydroxyphenyl)fluorine (BHPF), 9,9-bis(3,5-dimethyl-4-hydroxyphenyl)fluorene (BDMPF) or 9,9-bis(3,5-dibromo-4-hydroxyphenyl)fluorine (BFBPF), and a mixture of more than two of them can be used.

In addition, bis(hydroxyaryl)cyclo alkanes are also applicable, and specifically 1,1-bis(4,4-hydroxyphenyl)cyclopentane, 1,1-bis(4,4-hydroxyphenyl)cyclohexane, 1-methyl-1-(4-hydroxyphenyl)-4-(dimethyl-4-hydroxyphenyl)cyclohexane, 4-{1-[3-(4-hydroxyphenyl)-4-methylcyclohexyl]-1-methylethyl}phenol, 4,4-[1-methyl-4-(1-methylethyl)-1,3-cyclohexylidyl]bisphenol, or 2,2,2,2-tetrahydro-3,3,3,3-tetramethyl-1,1-spirobis-[1H]-indene-6,6-diol, and a mixture of more than two of them can also be used.

Dihydroxy diarylether is exemplified by bis(4-hydroxyphenyl)ether, bis(4-hydroxy-3,5-dichlorophenyl)ether and 4,4-dihydroxy-3,3-dimethylphenylether; dihydroxydiarylsulphide is exemplified by 4,4-dihydroxy diphenylsulphide and 4,4-dihydroxy-3,3-dimethyldiphenylsulphide; dihydroxy diarylsulphoxide is exemplified by 4,4-dihydroxy diphenylsulphoxide and 4,4-dihydroxy-3,3-dimethyldiphenylsulphoxide; dihydroxy siarylsulphonate is exemplified by 4,4-dihydroxy diphenylsulphone and 4,4-dihydroxy diphenylsulphone and 4,4-dihydroxy-3,3-dimethyldiphenylsulphone, etc, and each of them or a mixture of more than two of them can be used as the aromatic dihydroxy compound.

In the above formula, —OOCYCO— can be one of terephthalic acid, isophthalic acid, dibenzoic acid or naphthalene dicarboxylic acid in which aromatic group can be substituted with a substituent selected from a group consisting of C₁˜C₈ alkyl, aryl, alkylaryl and halogen, and/or a mixture comprising at least two of the above.

In particular, polyarylate containing the following repeating unit is preferably used in the present invention, but the structure of the repeating unit is not always limited to the following formula.

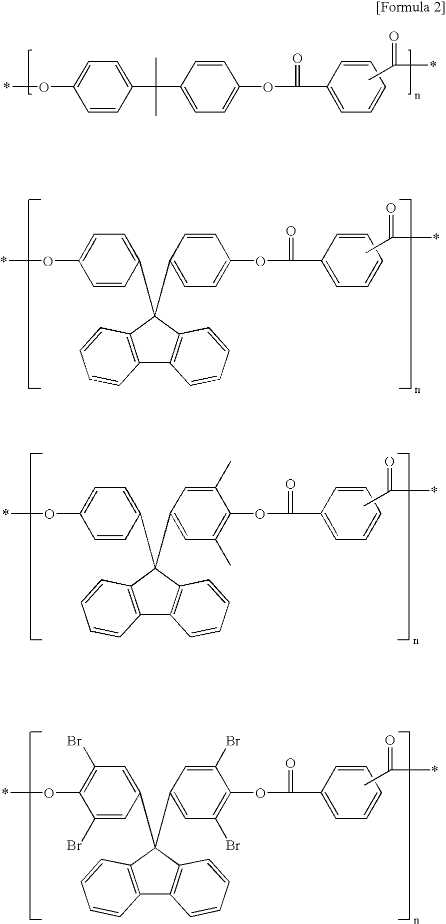

### BEST MODE FOR CARRYING OUT THE INVENTION

Practical and presently preferred embodiments of the present invention are illustrative as shown in the following Examples. However, it will be appreciated that those skilled in the art, on consideration of this disclosure, may make modifications and improvements within the spirit and scope of the present invention. And, the mentioned polyarylate is not always limited to the Synthetic Examples of the invention.

### SYNTHETIC EXAMPLE 1

To a reactor equipped with a stirrer were added 7.97 g of 2,2-bis(4-hydroxyphenyl)fluorene, 0.03 g of t-butylphenol, 2.01 g of NaOH, 48 g of distilled water and 23 g of 1,4-dioxane, followed by heating up to 70° C. with stirring for dissolving. The temperature of the reactor was lowered to 20° C., to which 0.39 g of benzyltriethylammoniumbromide and 5 g of methylenechloride were added and stirred hard. In the meantime, separately with the above reaction solution, 4.62 g of aromatic carboxylic acid mixture comprising equal amount of isophthalic acid and terephthalic acid was dissolved in 71 g of methylenechloride. The solution was added to the alkali aqueous solution prepared in advance. After one hour of polymerization, acetic acid was added to terminate the reaction. As much methylenechloride and twice as much distilled water as the volume of the total reaction solution were added, followed by washing several times. Washing was repeated until the conductivity of the solution was up to 50 μs/cm, then methanol was added to the solution to precipitate polymer.

### SYNTHETIC EXAMPLE 2

To a reactor equipped with a stirrer were added 6.55 g of 2,2-bis(4-hydroxyphenyl)fluorene, 1.42 g of 2,2-bis(4-hydroxyphenyl)propane, 0.038 g of t-butylphenol, 2.2 g of NaOH, 53 g of distilled water and 23 g of 1,4-dioxane, followed by heating up to 70° C. with stirring for dissolving. The temperature of the reactor was lowered to 20° C., to which 0.39 g of benzyltriethylammoniumbromide and 5 g of methylenechloride were added and stirred hard. In the meantime, separately with the above reaction solution, 5.05 g of aromatic carboxylic acid mixture comprising equal amount of isophthalic acid and terephthalic acid was dissolved in 64 g of methylenechloride. The solution was added to the alkali aqueous solution prepared in advance. After one hour of polymerization, acetic acid was added to terminate the reaction. As much methylenechloride and twice as much distilled water as the volume of the total reaction solution were added, followed by washing several times. Washing was repeated until the conductivity of the solution was up to 50 μs/cm, then methanol was added to the solution to precipitate polymer.

### SYNTHETIC EXAMPLE 3

To a reactor equipped with a stirrer were added 4.48 g of 2,2-bis(4-hydroxyphenyl)fluorene, 5.46 g of 2,2-bis(4-hydroxyphenyl)propane, 0.056 g of t-butylphenol, 3.25 g of NaOH, 62 g of distilled water and 23 g of 1,4-dioxane, followed by heating up to 70° C. with stirring for dissolving. The temperature of the reactor was lowered to 20° C., to which 0.48 g of benzyltriethylammoniumbromide and 6.5 g of methylenechloride were added and stirred hard. In the meantime, separately with the above reaction solution, 7.46 g of aromatic carboxylic acid mixture comprising equal amount of isophthalic acid and terephthalic acid was dissolved in 91 g of methylenechloride. The solution was added to the alkali aqueous solution prepared in advance. After one hour of polymerization, acetic acid was added to terminate the reaction. As much methylenechloride and twice as much distilled water as the volume of the total reaction solution were added, followed by washing several times. Washing was repeated until the conductivity of the solution was up to 50 μs/cm, then methanol was added to the solution to precipitate polymer.

### SYNTHETIC EXAMPLE 4

To a reactor equipped with a stirrer were added 9.93 g of 2,2-bis(4-hydroxyphenyl)propane, 0.066 g of t-butylphenol, 3.85 g of NaOH and 92 g of distilled water, followed by stirring for dissolving. The temperature of the reactor was kept at 20° C., to which 0.48 g of benzyltriethylammoniumbromide and 6.5 g of methylenechloride were added and stirred hard. In the meantime, separately with the above reaction solution, 8.84 g of aromatic carboxylic acid mixture comprising equal amount of isophthalic acid and terephthalic acid was dissolved in 106 g of methylenechloride. The solution was added to the alkali aqueous solution prepared in advance. After one hour of polymerization, acetic acid was added to terminate the reaction. As much methylenechloride and twice as much distilled water as the volume of the total reaction solution were added, followed by washing several times. Washing was repeated until the conductivity of the solution was up to 50 μs/cm, then methanol was added to the solution to precipitate polymer. The compositions, glass transition temperatures and molecular weights of polyarylates obtained in Synthetic Examples 1˜4 are shown in the below Table.

TABLE 1

| | Synthetic | Synthetic | Synthetic | Synthetic |
|---|---|---|---|---|
| | Example 1 | Example 2 | Example 3 | Example 4 |
| Duhydroxy monomer | 100:0 | 75:25 | 35:65 | 0:100 |
| composition (mol %) | | | | |
| (BHPF:BPA) | | | | |
| Tg (° C.) | 325 | 300 | 250 | 200 |
| Molecular weight (g/mol) | 78k | 44k | 98k | 98k |

BHPF: 2,2-bis(4-hydroxyphenyl)fluorene
BPA: 2,2-bis(4-hydroxyphenyl)propane

### SYNTHETIC EXAMPLE 5

To a reactor equipped with a stirrer were added 4.68 g of 9,9-bis(3,5-dimethyl-4-hydroxyphenyl)fluorene, 5.26 g of 2,2-bis(4-hydroxyphenyl)propane, 0.054 g of t-butylphenol, 3.16 g of NaOH, 75 g of distilled water and 23 g of 1,4-dioxane, followed by heating up to 70° C. with stirring for dissolving. The temperature of the reactor was lowered to 20° C., to which 0.48 g of benzyltriethylammoniumbromide and 8 g of methylenechloride were added and stirred hard. In the meantime, separately with the above reaction solution, 7.2 g of aromatic carboxylic acid mixture comprising equal amount of isophthalic acid and terephthalic acid was dissolved in 89 g of methylenechloride. The solution was added to the alkali aqueous solution prepared in advance. After one hour of polymerization, acetic acid was added to terminate the reaction. As much methylenechloride and twice as much distilled water as the volume of the total reaction solution were added, followed by washing several times. Washing was repeated until the conductivity of the solution was up to 50 μs/cm, then methanol was added to the solution to precipitate polymer.

### SYNTHETIC EXAMPLE 6

To a reactor equipped with a stirrer were added 6.09 g of 9,9-bis(3,5-dibromo-4-hydroxyphenyl)fluorene, 3.87 g of 2,2-bis(4-hydroxyphenyl)propane, 0.04 g of t-butylphenol, 2.31 g of NaOH, 55 g of distilled water and 27 g of 1,4-dioxane, followed by heating up to 70° C. with stirring for dissolving. The temperature of the reactor was lowered to 20° C., to which 0.48 g of benzyltriethylammoniumbromide and 5.5 g of methylenechloride were added and stirred hard. In the meantime, separately with the above reaction solution, 5.3 g of aromatic carboxylic acid mixture comprising equal amount of isophthalic acid and terephthalic acid was dissolved in 80 g of methylenechloride. The solution was added to the alkali aqueous solution prepared in advance. After one hour of polymerization, acetic acid was added to terminate the reaction. As much methylenechloride and twice as much distilled water as the volume of the total reaction solution were added, followed by washing several times. Washing was repeated until the conductivity of the solution was up to 50 μs/cm, then methanol was added to the solution to precipitate polymer. The compositions, glass transition temperatures and molecular weights of polyarylates obtained in Synthetic Examples 1˜2 are shown in the below Table.

TABLE 2

| | Synthetic | |
|---|---|---|
| | Example 5 | Synthetic Example 6 |
| Dihydroxy monomer composition | 35:65 | — |
| (mol %) | | |
| (BDMPF:BPA) | | |
| Dihydroxy monomer composition | — | 35:65 |
| (mol %) | | |
| (BDBPF:BPA) | | |
| Tg (° C.) | 256 | 273 |
| Molecular weight (g/mol) | 81k | 80k |

BDMPF: 9,9-bis(3,5-dimethyl-4-hydroxyphenyl)fluorene
BDBPF: 9,9-bis(3,5-dibromo-4-hydroxyphenyl)fluorine

### EXAMPLE 1˜EXAMPLE 4

Three types of polyarylates prepared in the above Synthetic Examples proceeded to prepare films by solution casting, then phase differences toward thickness direction and in-plane direction were measured. First, polymerized polyarylate was dissolved in dichloroethane solvent at the concentration of 10 weight %, resulting in a polymer solution. For the even concentration of the polymer solution, a solvent and polyarylate were mixed and the temperature of the mixture was raised to 70° C. The solution was casted on glass plate by bar coating, resulting in a 80 μm thick film. The film casted on the glass plate was fixed to prevent the size change and then dried for 6 hours at room temperature. After separating the film from the glass plate, the remaining solvent was completely dried out at 200° C. The elimination of the remaining solvent was confirmed by the temperature-dependent weight decrease detected by thermal analyzer. Phase difference toward out of plane direction of film was calculated by using the following mathematical formula in which phase difference was measured at 50° and −50° of light to the surface of the film.

$${R}_{th} = \frac{( {R}_{θ} - {R}_{i n ( θ = 0 )} ) \times cos θ}{{sin}^{2} θ} \qquad [ Mathematical Formula 3 ]$$

Wherein, Rₜₕ indicates the phase difference toward out of plane direction, R_{θ} indicates the phase difference at θ angle, Rᵢₙ indicates the phase difference toward in-plane direction at θ=0, and θ is the angle of film surface and light.

### COMPARATIVE EXAMPLE 1

Experiment was performed by the same manner as described in Example 1 except that a film was prepared by solution casting from PC (polycarbonate, Teijin Co.) and phase differences toward out of plane direction and in-plane direction were measured.

### COMPARATIVE EXAMPLE 2

Experiment was performed by the same manner as described in Comparative Example 1 except that TAC (Fuji Co.) was used instead of PC.

### COMPARATIVE EXAMPLE 3

Experiment was performed by the same manner as described in Comparative Example 2 except that TAC film prepared by solution casting was stretched and then phase differences toward out of plane direction and in-plane direction were measured.

TABLE 3

| | | | BPA | | Film | | | |
|---|---|---|---|---|---|---|---|---|
| | | Synthetic | content | MW | thickness | Rᵢₙ | Total | |
| | | Example | (wt %) | (g/mol) | (μm) | (nm) | Rₜₕ(nm) | Rₜₕ/μm |
| Example | 1 | 2 | 10 | 44,000 | 90 | 2 | −83 | −0.9 |
| | 2 | 2 | 10 | 130,000 | 101 | 3 | −345 | −3.5 |
| | 3 | 3 | 35 | 98,000 | 96 | 3 | −825 | −8.6 |
| | 4 | 4 | 100 | 98,000 | 74 | 2 | −838 | −11.3 |
| Comparative | 1 | — | 50 | 88.000 | 100 | 2 | 59.3 | 0.59 |
| Example | 2 | — | 0 | 169,000 | 80 | 1 | 55 | 0.69 |
| | 3 | — | 0 | 197,000 | 92 | 33 | 148 | 1.61 |

Mathematical formula 1 defines Rₜₕ, precisely, in which Rₜₕ is defined by the relation of different reflective index rates at each direction. In the meantime, mathematical formula 3 shows a relational expression measuring Rₜₕ. Most Rₜₕ values can be calculated by mathematical formula 3 using transmittance data and the results of the Examples of the invention were also calculated by the mathematical formula 3.

### EXAMPLE 5˜EXAMPLE 8

In Examples 5˜8, thickness dependent phase differences of a film were investigated. Polyarylate used in those Examples was synthesized with 100% bisphenol A in Synthetic Example 4, and had glass transition temperature of 200° C. and molecular weight of 98,000 g/mol. Films were prepared by the same manner as described in Examples 1˜4, except that the film thickness was differently regulated.

TABLE 4

Example

| | 5 | 6 | 7 | 8 |
|---|---|---|---|---|
| Film thickness (μm) | 100 | 50 | 30 | 10 |
| Rᵢₙ (nm) | 2 | 3 | 2.5 | 3.5 |
| Rₜₕ (nm) | −1200 | −850 | −570 | −250 |

As shown in Table 4, phase difference can be regulated by the film thickness and the reduction of the film thickness can secure proper phase difference for a compensator film.

### INDUSTRIAL APPLICABILITY

Since polyarylate film of the present invention has 20 times as high negative birefringence toward out of plane direction as a film prepared by stretching, it can be used as a negative C type compensator film for LCD with improved view angle.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A compensator film for LCD, which is characteristically polyarylate film having phase difference of −30 nm˜−2000 nm defined as the following mathematical formula 1.
$${R}_{th} = ( {n}_{z} - \frac{{n}_{x} + {n}_{y}}{2} ) \times d \qquad [ Mathematical Formula 1 ]$$
Wherein, Rₜₕ indicates the phase difference toward out of plane direction, nₓ and n_{y} indicate reflective index toward in-plane direction of film, n_{z} indicates reflective index toward out of plane direction of film and d indicates the film thickness (nm).

2. The compensator film as set forth in claim 1, wherein the thickness of the polyarylate film is regulated to have phase difference of −30 nm˜−300 nm.

3. The compensator film as set forth in claim 1, wherein the polyarylate is a polymer represented by the following formula 1. 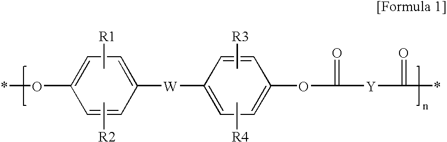
Wherein, R1, R2, R3 and R4 are independently hydrogen, C₁˜C₁₂ alkyl, C₆˜C₁₂ arylalkyl), C₆˜C₁₂ aryl, C₁˜C₁₂ nitrile, C₁˜C₁₂ alkoxy, C₁˜C₁₂ acyl or halogen, W is C₁˜C₃₀ alkylidene, C₂˜C₃₀ alkylene, C₃˜C₃₀ cycloalkylidene, C₃˜C₃₀ cycloalkylene or phenyl-substituted C₂˜C₃₀ alkylene, fluorene, oxygen, sulfur, sulfoxide, sulfone or single bond.
And, —OOCYCO— can be one of terephthalic acid, isophthalic acid, dibenzoic acid or naphthalene dicarboxylic acid in which aromatic group can be substituted with a substituent selected from a group consisting of C₁˜C₈ alkyl, aryl, alkylaryl and halogen, and/or a mixture comprising at least two of the above.

4. The compensator film as set forth in claim 1, wherein the polyarylate is composed of homopolymer or copolymer of more than two kinds of polymers.

5. The compensator film as set forth in claim 1, wherein the polyarylate is homopolymer.

6. The compensator film as set forth in claim 1, wherein the polyarylate is homopolymer prepared by polymerization of a monomer selected from a group consisting of 2,2-bis(4-hydroxyphenyl)propane (BPA), 4,4-dihydroxyphenyl-9,9-fluorene, 2,2-bis(4-hydroxyphenyl)fluorene (BHPF), 9,9-bis(3,5-dimethyl-4-hydroxyphenyl)fluorene (BDMPF) and 9,9-bis(3,5-dibromo-4-hydroxyphenyl)fluorene (BFBPF) with another monomer selected among isophthaloyl chloride and terephthaloyl chloride.

7. The compensator film as set forth in claim 4, wherein the polyarylate copolymer is prepared from monomers containing fluorene group.

8. The compensator film as set forth in claim 4, wherein the phase difference per unit thickness (μm) of the homopolymer of polyarylate is −5 nm/μm˜−15 nm/μm defined as mathematical formula 2.
$${r}_{th} = \frac{{R}_{th}}{t} \qquad [ Mathematical Formula 2 ]$$
Wherein, rₜₕ indicates the phase difference per unit thickness, Rₜₕ indicates the phase difference toward out of plane direction (nm), and t indicates the film thickness (μm).

9. The compensator film as set forth in claim 4, wherein the phase difference per unit thickness (μm) of the copolymer of polyarylate is −5 nm/μm˜−10 nm/μm defined as mathematical formula 2.

10. The compensator film as set forth in claim 1, wherein the polyarylate film is prepared from polyarylate having at least 20,000 g/mol of molecular weight.

11. The compensator film as set forth in claim 1, wherein the polyarylate film is prepared from polyarylate synthesized by using diatomic phenol and diatomic carboxylic acid halide as major components.

12. The compensator film as set forth in claim 1, wherein the polyarylate film is surface-treated by a method selected from a group consisting of corona treatment, acid/base treatment and UV treatment.

13. The compensator film as set forth in claim 1, wherein the thickness of the polyarylate film is up to 200 μm.

14. The compensator film as set forth in claim 1, wherein the compensator film for LCD is applied to vertical alignment LCD.

15. The compensator film as set forth in claim 1, wherein the compensator film for LCD is applied to twist nematic LCD.

16. The compensator film as set forth in claim 1, wherein the compensator film for LCD is characteristically applied to sheet switching LCD.

17. A preparation method for the polyarylate compensator film of claim 1 comprising the following steps:
preparing polyarylate solution by using one or more organic solvents selected from a group consisting of methylenechloride, dichloroethane and tetrahydrofuran;
preparing cast film by coating a substrate with the polyarylate solution and vaporizing solvents slowly at room temperature or up to 50° C.; and
preparing polyarylate compensator film by fixing the cast film on a frame designed to receive force evenly and drying thereof.

18. The preparation method for the polyarylate compensator film as set forth in claim 17, wherein the concentration of the polyarylate solution is 5˜35 weight %.

19. The compensator film as set forth in claim 3, wherein the polyarylate is homopolymer prepared by polymerization of a monomer selected from a group consisting of 2,2-bis(4-hydroxyphenyl)propane (BPA), 4,4-dihydroxyphenyl-9,9-fluorene, 2,2-bis(4-hydroxyphenyl)fluorene (BHPF), 9,9-bis(3,5-dimethyl-4-hydroxyphenyl)fluorene (BDMPF) and 9,9-bis(3,5-dibromo-4-hydroxyphenyl)fluorene (BFBPF) with another monomer selected among isophthaloyl chloride and terephthaloyl chloride.

20. The compensator film as set forth in claim 4, wherein the polyarylate is homopolymer prepared by polymerization of a monomer selected from a group consisting of 2,2-bis(4-hydroxyphenyl)propane (BPA), 4,4-dihydroxyphenyl-9,9-fluorene, 2,2-bis(4hydroxyphenyl)fluorene (BHPF), 9,9-bis(3,5-dimethyl-4-hydroxyphenyl)fluorene (BDMPF) and 9,9-bis(3,5-dibromo-4-hydroxyphenyl)fluorene (BFBPF) with another monomer selected among isophthaloyl chloride and terephthaloyl chloride.

21. The compensator film as set forth in claim 5, wherein the polyarylate is homopolymer prepared by polymerization of a monomer selected from a group consisting of 2,2-bis(4-hydroxyphenyl)propane (BPA), 4,4-dihydroxyphenyl-9,9-fluorene, 2,2-bis(4-hydroxyphenyl)fluorene (BHPF), 9,9-bis(3,5-dimethyl-4-hydroxyphenyl)fluorene (BDMPF) and 9,9-bis(3,5-dibromo-4-hydroxyphenyl)fluorene (BFBPF) with another monomer selected among isophthaloyl chloride and terephthaloyl chloride.

22. The compensator film as set forth in claim 5, wherein the phase difference per unit thickness (μm) of the homopolymer of polyarylate is −5 nm/μm˜−15 nm/μm defined as mathematical formula 2.
$${r}_{th} = \frac{{R}_{th}}{t} \qquad [ Mathematical Formula 2 ]$$
Wherein, rₜₕ indicates the phase difference per unit thickness, Rₜₕ indicates the phase difference toward out of plane direction (nm), and t indicates the film thickness μm.

23. The compensator film as set forth in claim 7, wherein the phase difference per unit thickness (μm) of the copolymer of polyarylate is −5 nm/μm˜−10 nm/μm defined as mathematical formula 2.
